(19) United States
(12) Patent Application Publication
(10) Pub. No.: US 2024/0094781 A1
(43) Pub. Date: Mar. 21, 2024

(54) MODULAR COMPUTER SYSTEM

(71) Applicant: Framework Computer LLC, Burlingame, CA (US)

(72) Inventors: Nirav Patel, San Francisco, CA (US); Poyu Chen, Taipei (TW); Travis Liu, Taipei (TW); Anthony Ye, Taipei (TW); Daniel Schaefer, Taipei (TW)

(21) Appl. No.: 18/373,801

(22) Filed: Sep. 27, 2023

Related U.S. Application Data
(63) Continuation-in-part of application No. 17/949,061, filed on Sep. 20, 2022.
Application No. 17/949,061 is a continuation-in-part of application No. 17/736,765, filed on May 4, 2022.
(60) Provisional application No. 63/410,447, filed on Sep. 27, 2022.
(60) Provisional application No. 63/411,483, filed on Sep. 29, 2022.
(60) Provisional application No. 63/246,043, filed on Sep. 20, 2021.
(60) Provisional application No. 63/186,443, filed on May 10, 2021.

(51) Int. Cl. G06F 1/16

(52) U.S. Cl. CPC G06F 1/1669; G06F 1/1616; G06F 1/169

(57) ABSTRACT

One variation of a modular keyboard system includes a chassis; a keyboard module; and a trackpad module. The chassis includes a controller and an input deck. The input deck includes an array of couplers, each coupler in the array of couplers including a magnetic element and an electronic communication port. The keyboard module includes a first connector configured electronically and magnetically couple a first coupler, in the array of couplers, to transiently retain the keyboard module in a first configuration spanning an upper region of the input deck and transmit electrical signals from a set of keys to the controller. The trackpad module includes a second connector configured to electronically and magnetically couple a second coupler, in the array of couplers, to transiently retain the trackpad module in a second configuration spanning a lower region of the input deck and transmit electrical signals from a touch sensor to the controller.

### CROSS-REFERENCE TO RELATED APPLICATIONS

This application claims priority to U.S. Provisional Application No. 63/410,447, filed on 27 Sep. 2022, and 63/411,483, filed on 29 Sep. 2022, each of which is incorporated in its entirety by this reference.

This application is a continuation-in-part of U.S. Non-Provisional application Ser. No. 17/949,061, filed on 20 Sep. 2022, which claims the benefit of U.S. Provisional Application No. 63/246,043, filed on 20 Sep. 2021, each of which is incorporated in its entirety by this reference.

This application is a continuation-in-part of U.S. Non-Provisional application Ser. No. 17/736,765, filed on 4 May 2022, which claims the benefit of U.S. Provisional Application No. 63/186,443, filed on 10 May 2021, each of which is incorporated in its entirety by this reference.

### TECHNICAL FIELD

This invention relates generally to the field of computing devices and more specifically to a new and useful method for a modular computer system in the field of computing devices.

### BRIEF DESCRIPTION OF THE FIGURES

FIG. 1 is a schematic representation of the modular computer system;

FIG. 2 is schematic representation of the modular computer system;

FIGS. 3A and 3B are schematic representations of the modular computer system;

FIGS. 4A and 4B are schematic representations of the modular computer system;

FIGS. 5A and 5B are schematic representations of the modular computer system;

FIG. 6 is a schematic representation of the modular computer system;

FIG. 7 is a schematic representation of the modular computer system;

FIG. 8 is a schematic representation of the modular computer system; and

FIG. 9 is a schematic representation of the modular computer system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

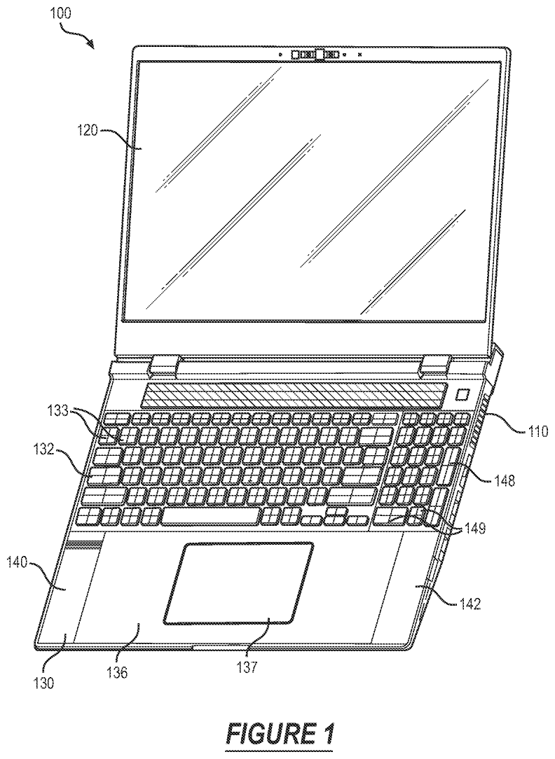

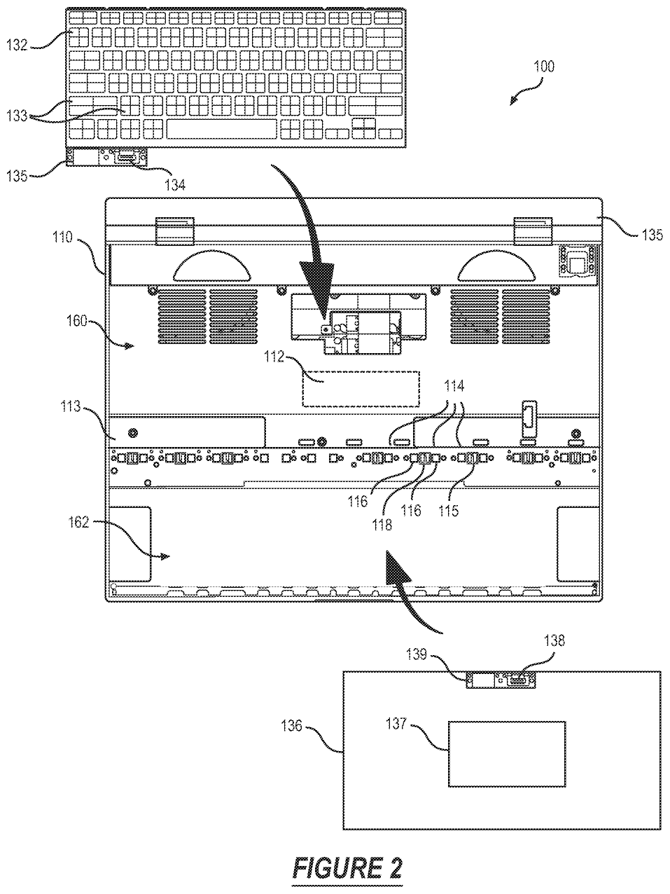

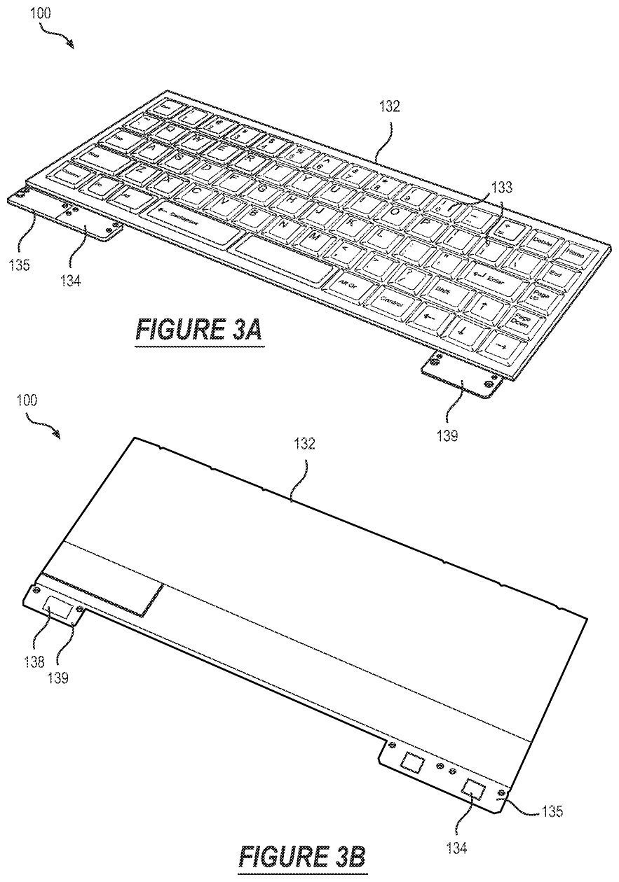

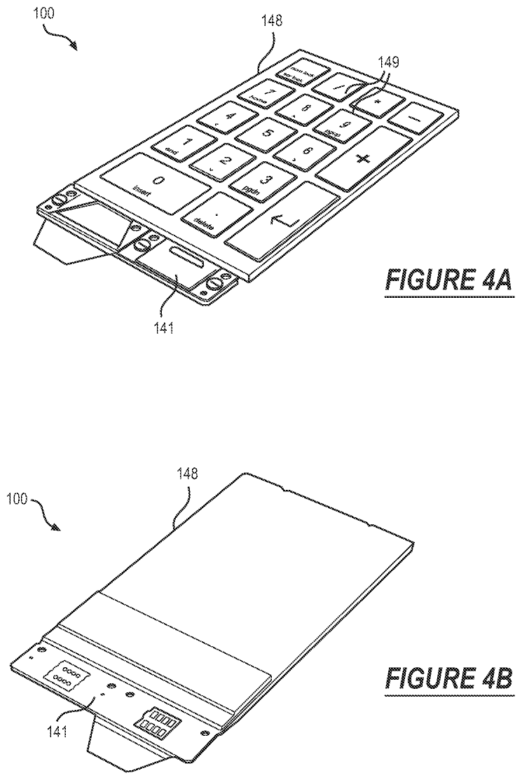

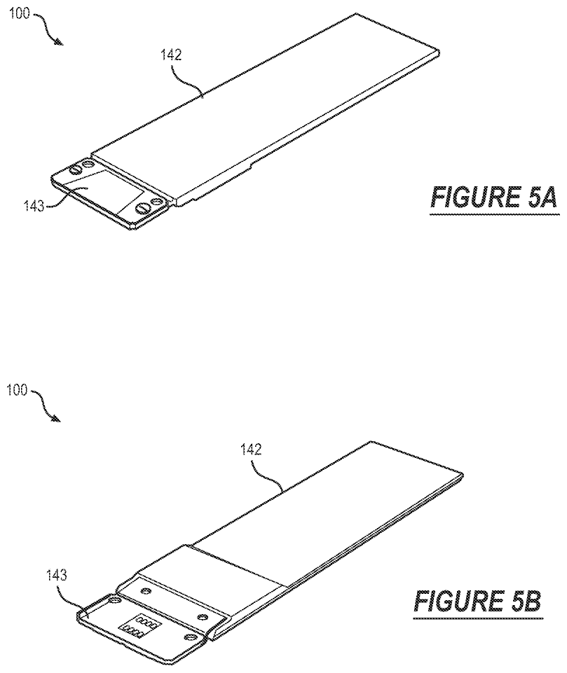

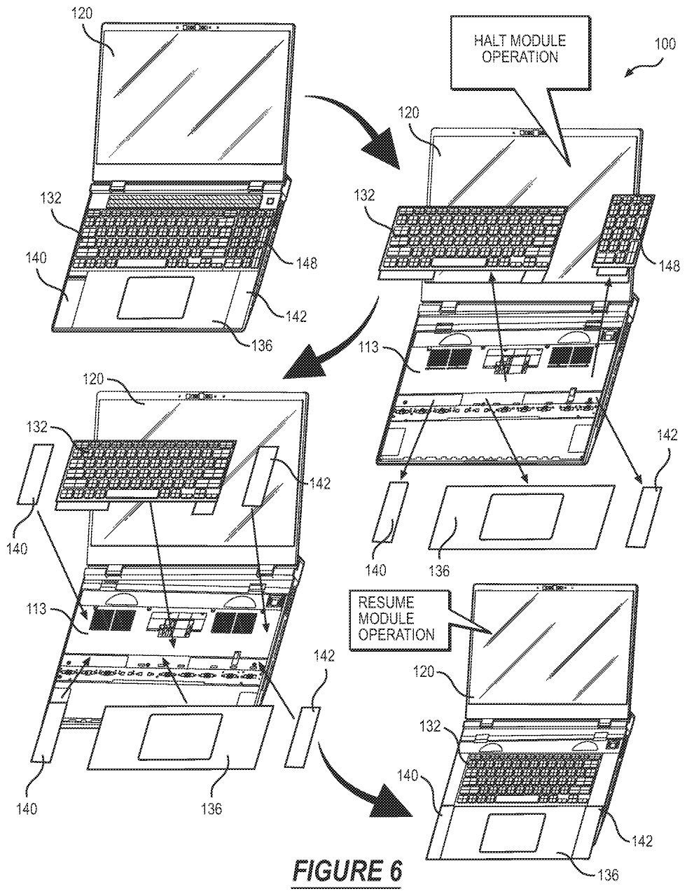

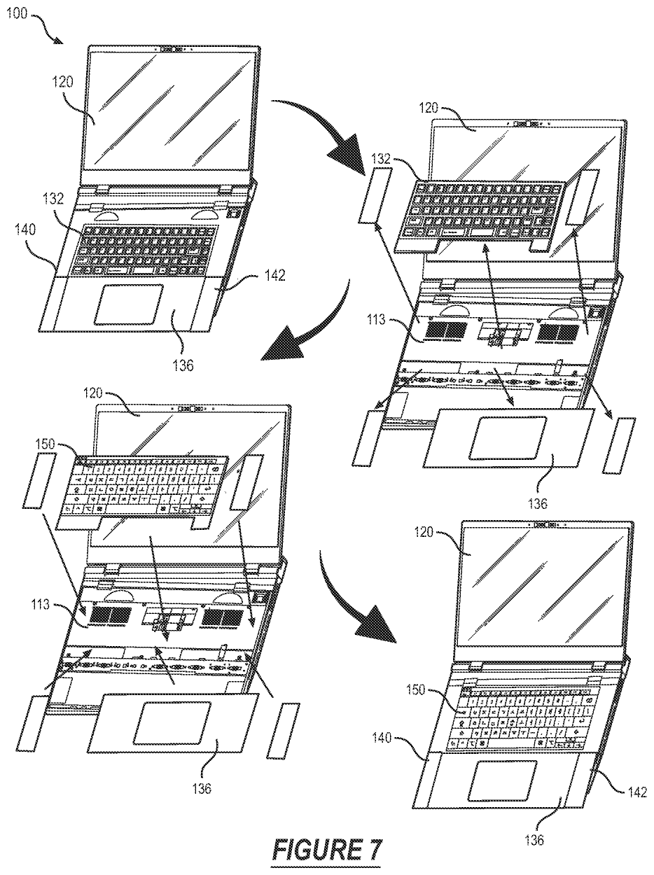

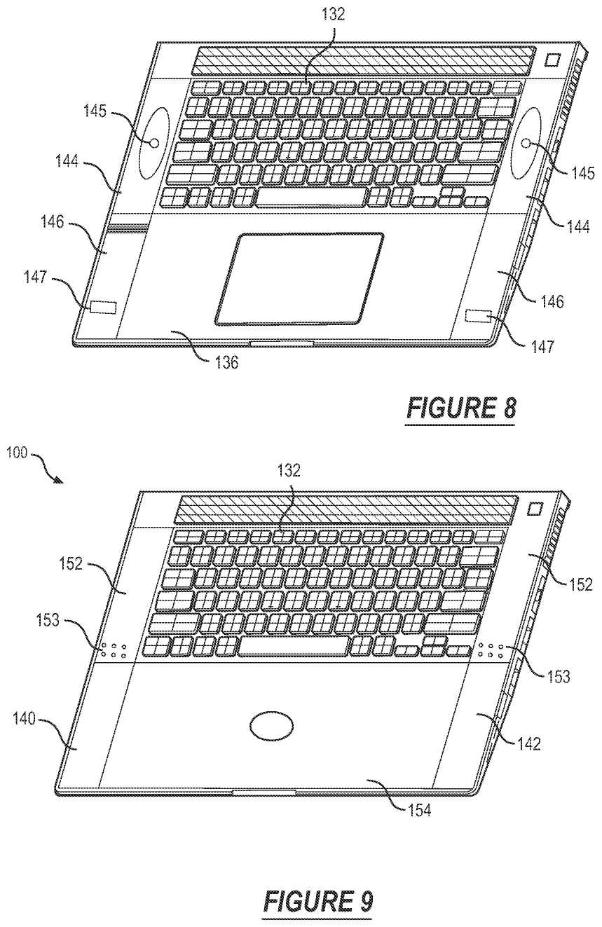

As shown in FIGS. 1, 2, 3A, and 3B a modular computer system 100 includes: a chassis 110; a display 120; and a module kit 130 including a keyboard module 132, a trackpad module 136, and a set of spacer modules.

The chassis 110 includes: a controller 112; an input deck 113 defining an array of connector locations 114; and an array of couplers 115. Each coupler in the array of couplers 115: is arranged at a connector location, in the array of connector locations 114, on the input deck 113; and a magnetic element 116 and an electronic communication port. The display 120 is coupled (e.g., pivotably coupled) to the chassis 110.

The keyboard module 132 includes: an array of keys 133 arranged on a first side of the keyboard module 132; and a first connector 134. The first connector 134: is arranged on a second side, opposite the first side, of the keyboard module 132; is configured to magnetically couple the array of couplers 115 to transiently retain the keyboard module 132 across the input deck 113; and is configured to electronically couple to the array of couplers 115 to transmit electrical signals from the array of keys 133 to the controller 112.

The trackpad module 136 includes: a touch sensor 137 arranged on a first side of the trackpad module 136; and a second connector 138. The second connector 138: is arranged on a second side, opposite the first side, of the trackpad module 136; is configured to magnetically couple the array of couplers 115 to transiently retain the trackpad module 136 across the input deck 113; and is configured to electronically couple the array of couplers 115 to transmit electrical signals from the touch sensor 137 to the controller 112.

Each spacer module, in the set of spacer modules, includes: a rectangular geometry; and a spacer module connector configured to magnetically couple the array of couplers 115 to transiently retain the spacer module across the input deck 113.

The module kit 130 is operable in a first configuration in which the keyboard module 132 spans an upper region 160 of the input deck 113 and in which the trackpad module 136 spans a lower region 162, adjacent the upper region 160, of the input deck 113. The first configuration further includes the set of spacer modules cooperating with the keyboard module 132 and the trackpad module 136: to enclose regions of the input deck 113 outside of the keyboard module 132 and the trackpad module 136; and to retain lateral positions of the keyboard module 132 and the trackpad module 136 in the first configuration.

Additionally, the module kit 130 is operable in a second configuration in which the keyboard module 132 spans a lower region 162 of the input deck 113 and in which the trackpad module 136 spans an upper region 160, adjacent the lower region 162, of the input deck 113. The second configuration further includes the set of spacer modules cooperating with the keyboard module 132 and the trackpad module 136 to: enclose regions of the input deck 113 outside the keyboard module 132 and the trackpad module 136; enclose regions of the input deck 113 outside of the keyboard module 132 and the trackpad module 136; and retain lateral positions of the keyboard module 132 and the trackpad module 136 in the first configuration.

### 2. Applications

Generally, the modular computer system 100 can operate as a standalone computing device (e.g., a 16-inch laptop computing device) including a set of exchangeable modules to accommodate a user's interface preferences during operation of the modular computer system 100. In particular, the modular computer system 100 can include a trackpad module 136 and a keyboard module 132 selectively positioned across a chassis 110 for a mobile computing device.

More specifically, the modular computer system 100 can include: a foldable chassis no; an input deck 113; a keyboard module 132; and a trackpad module 136. The foldable chassis 110 can include a set of computing components, such as a main board, a controller 112, a fan, and a memory component arranged within a first housing of the foldable chassis no. Additionally, the foldable chassis 110 includes a display 120 arranged within a second housing and connected to the mainboard, thereby forming a foldable computing device.

The input deck 113: is arranged over the first housing of the chassis no; and defining an array of connector locations 114 arranged across the input deck 113. Additionally, the input deck includes a coupler located at each connector location in the set of connector locations to form an array of couplers 115. Additionally, each coupler across the input deck 113 includes an electronic communication port 118 and a magnetic element 116. The keyboard module 132 and the trackpad module 136 can be selectively arranged across the input deck 113 by selectively coupling these modules to the connector locations across the input deck 113. The keyboard module 132 and the trackpad module 136 can each include a connector tab: formed of a ferrous material configured to magnetically couple the magnetic element 116 at the connector location; and including a module connector configured to communicably couple the electronic communication port 118 at the connector location.

In one example, the keyboard module 132 and the trackpad module 136 can be selectively arranged in a left-sided configuration across the input deck 113 of the chassis no. In this example, the keyboard module 132 is arranged across an upper region 160 of the input deck 113 and the trackpad module 136 is arranged across a lower region 162 of the input deck 113. The keyboard module 132: spans a first area across the upper region 160 of the input deck 113; is arranged proximal a left lateral side of the first housing of the chassis no; defines a second area proximal the right lateral side of the first housing and adjacent the first area on the upper region 160 of the input deck 113; and includes a first connector tab 135 coupled to a first connector location proximal the left lateral side of the first housing. A spacer module can be arranged at the second area of the upper region 160 of the input deck 113 to thereby: entirely overlay the upper region 160 of the input deck 113; and maintain the keyboard module 132 in the left-sided configuration.

In the aforementioned example, the trackpad module 136: spans a third area across the lower region 162 of the input deck 113; is arranged proximal a left-lateral side of the first housing of the chassis 110; defines a fourth area adjacent the third area on the lower region 162 of the input deck 113; and includes a second connector tab 139 coupled to a second connector location, in the array of connector locations 114, proximal the left-lateral side of the first housing. Furthermore, an additional spacer module can be arranged at the fourth area of the lower region 162 of the input deck 113 to thereby: entirely overlay the lower region 162 of the input deck 113; and maintain the trackpad module 136 in the left-sided configuration.

In another example, the keyboard module 132 and the trackpad module 136 can be selectively arranged in a right-sided configured across the input deck 113 of the chassis 110. In this example, the keyboard module 132: spans a first area across the upper region 160 of the input deck 113; is arranged proximal a right lateral side of the first housing of the chassis 110; defines a second area proximal the left lateral side of the first housing and adjacent the first area on the upper region 160 on the input deck 113; and includes a first connector tab 135 coupled to a first connector location proximal the right lateral side of the first housing. A spacer module can be arranged at the second area of the upper region 160 of the input deck 113 to thereby: entirely overlay the upper region 160 of the input deck 113; and maintain the keyboard module 132 in the right-sided configuration.

In this aforementioned example, the trackpad module 136: spans a third area across the lower region 162 of the input deck 113; is arranged proximal a right-lateral side of the first housing of the chassis 110; defines a fourth area proximal the left lateral side of the first housing and adjacent the third area on the lower area of the input deck 113; and includes a second connector tab 139 coupled to a second connector location, in the array of connector locations 114, proximal the right-lateral side of the first housing. Furthermore, an additional spacer module can be arranged at the fourth area of the lower region 162 of the input deck 113 to thereby: entirely overlay the lower region 162 of the input deck 113; and maintain the trackpad module 136 in the right-sided configuration.

In yet another example, the keyboard module 132 and the trackpad module 136 can be arranged in a center configuration across the input deck 113 of the chassis 110. In this example, the keyboard module 132: spans a first area across the upper region 160 of the input deck 113; is arranged at a center region of the input deck 113; defines a second area proximal the right lateral side of the first housing and adjacent the first area on the upper region 160 of the input deck 113; and defines a third area proximal the left lateral side of the first housing and adjacent the first area on the upper region 160 of the input deck 113. Additionally, the keyboard module 132 includes a first connector tab 135 coupled to a first connector location proximal the center region of the input deck 113. A first set of spacer modules can be arranged at the second area and the third area of the upper region 160 of the input deck 113 to thereby: entirely overlay the upper region 160 of the input deck 113; and maintain the keyboard module 132 in the center configuration.

In this aforementioned example, the trackpad module 136: spans a fourth area across the lower region 162 of the input deck 113; is arranged at a center region of the input deck 113; defines a fifth area proximal the right lateral side of the first housing and adjacent the fourth area of the lower region 162 of the input deck 113; and defines a sixth area proximal the left lateral side of the first housing and adjacent the fourth area on the lower region 162 of the input deck 113. Additionally, the trackpad module 136 includes a second connector tab 139 coupled to a second connector location, in the array of connector locations 114, proximal the center region of the input deck 113. Furthermore, a second set of spacer modules can be arranged at the fifth area and the sixth area of the lower region 162 of the input deck 113 to thereby: entirely overlay the lower region 162 of the input deck 113; and maintain the trackpad module 136 in the center configuration.

Therefore, the modular computer system 100 can: transiently receive the trackpad module 136 and the keyboard module 132 about multiple positions across the input deck 113 to accommodate for a user's preferences during operation of the modular computer system 100; read touch inputs from the trackpad module 136 regardless of positional arrangement across the input deck 113; and read key inputs from the keyboard module 132 regardless of positional arrangement across the input deck 113.

Additionally or alternatively, the modular computer system 100 can include additional modules, such as speaker modules, gamepad modules, musical keyboard module 132s, and stream deck modules arrangeable across the input deck 113 of the chassis 110.

In another example, the modular computer system 100 includes a set of input modules to enable for localization at different countries and regions—which implement keyboard decks of different languages and layouts—without the need of modifying the C-deck and chassis 110 of the modular computer system 100 during the manufacturing process thereby reducing cost and excess inventory. As a result, the modular computer system 100 can include keyboard input modules manufactured in different languages (e.g., English, Korean, Spanish) and layouts (e.g., QWERTY, ANSI, ISO) according to preferences and standard across different regions and countries. Additionally, the input module can be customized, such as by including backlights, and customized key mappings (e.g., gaming key mappings) for a user.

### 3. Chassis

In one implementation, the modular computer system 100 includes a chassis 110: arranged in a clamshell configuration; and including a first housing pivotably attached to a second housing in order to form a compact (i.e., foldable) modular computer system 100. In this implementation, the first housing includes: a first set of computing components; an input deck 113 arranged over the first set of computing components; the trackpad module 136 and the keyboard module 132 arranged across the input deck 113; and the set of spacer modules arranged across the input deck 113 adjacent the trackpad module 136 and the keyboard module 132. Additionally, the second housing: is congruent to the first housing; and includes a display 120 (e.g., 16-inch display element) connected to the first housing and configured to interface with the keyboard module 132 and the trackpad module 136.

In one example, the first housing can include a first set of computing elements including a battery, a main board, a fan, a controller 112, a memory component, a storage component, a controller 112, a wireless communications component, a graphics processing unit, and speakers. In this example, each computing component in the set of computing components are selectively attachable within the chassis 110 by a uniform set of fasteners. In particular the uniform set of fensters can transiently secure a first computing component, in the set of computing components, within the first housing of the chassis 110, and/or to a second computing component within the first housing of the chassis 110, such as to the battery, main board, and input deck 113.

In the aforementioned example, the second housing: is congruent the first housing; is pivotably attached to the first housing; and includes a display 120 (e.g., 16-inch display element) arranged within the second housing and connected to the graphics processing unit within the first housing. The display 120 can transiently couple the second housing via the uniform set of fasteners, thereby enabling the display 120 to be selectively removable from the second housing.

### 4. Expansion Computing Components

Generally, the modular computer system 100 can include an expansion card and an expansion module, each transiently mounted to the first housing of the chassis 110 and configured to interface the computing components within the chassis no.

### 4.1 Expansion Card Slot

In one implementation, the system can include an expansion card slot: arranged on a side end of the first housing: and configured to receive an expansion card, such that the expansion card is flush with a lateral side face and a bottom side face of the first housing when coupled to the expansion card slot. In this implementation, the expansion card slot: can be located on a bottom side of the first housing, opposite the input deck 113; and is inset from the bottom side of the first housing toward a top side of the first housing, thereby allowing for the expansion card slot to be accessible to a user from an exterior of the modular computer system 100 without removing other components from the first housing. Furthermore, the expansion card slot can include an expansion input: electrically connected to the main board within the first housing; and interfacing with a connector (e.g., USB-type C connectors, USB-type A connectors) of the expansion card.

In one example, the expansion card interfaces with the expansion input of the expansion card slot to form an electrical and data connection between the expansion card and the main board within the first housing. The controller 112 within the first housing can then: identify a type of expansion card inserted within the expansion card slot; and route inbound electrical signals received at the expansion input to a particular computing component within the modular computer system 100. Furthermore, the controller 112 can route outbound electrical signals, from computing components within the chassis 110, to the expansion input of the expansion card slot.

Additionally, in this example the main board, expansion card slot, and expansion card utilize data transfer protocols, such as USB 2.0 and USB 3.0, to communicate data via electrical signals to computing components within the chassis 110. Furthermore, the expansion card slot at the first housing can include a mechanical latching mechanism to maintain the expansion card in a connected position within the expansion card slot.

### 4.2 Expansion Card

In one implementation, the modular computer system 100 includes an expansion card including a card housing, a printed circuit board, a computer-side connector, and an external connector. In this implementation, the expansion card can be configured to accommodate a variety of common external computer connection types. In particular, the expansion card can include an external connector (i.e., female external computer connector) that receives a male port connector, such as an HDMI connector, a USB type-A connector, a display 120 port connector, or a USB type-C connector. The expansion card can route electrical signals (e.g., power signals, data signals) from the computer-side connector to the external connector of the expansion card.

For example, the expansion card can include: a computer side connector; an external power connector; and a power module arranged within the card housing configured to modify a power signal input received at the external power connector and output the power signal to a battery component within the chassis 110 of the modular computer system 100 via the computer side connector.

In another example, the modular computer system 100 includes an expansion card including a card housing, a storage module, and a computer-side connector. In this example, the computer-side connector of the expansion card interfaces with the connector of the expansion card slot to connect the storage module of the expansion card to the computing components within the chassis 110, thereby enabling the modular computer system 100 to include an external storage component.

In one implementation, the modular computer system 100 can include an expansion card including: an alignment groove arranged about lateral side walls of the expansion card; and a latch receiver arranged at a distal end of the alignment groove and configured to couple the mechanical latching mechanism of the expansion card slot. In this implementation, the alignment groove: defines a lateral channel inset from opposing side walls of the expansion card; and transiently couples to the rails of the expansion card slot to guide the expansion card within the expansion card slot, thereby preventing misalignment between the computer-side connector and the expansion input. The latch receiver interfaces with the mechanical latching mechanism to maintain the expansion card within the expansion card slot. Furthermore, the modular computer system 100 can include a lock release button disposed proximal the expansion card slot that, when actuated, is configured to disengage the latch receiver of the expansion card from the mechanical latching mechanism of the expansion card slot, thereby allowing for removal of the expansion card from the expansion card slot.

### 5. Input Deck

In one implementation, the modular computer system 100 includes an input deck 113: arranged across the first housing of the chassis 110; and defining an array of connector locations 114 arranged across the input deck 113. Additionally, the input deck 113 includes a coupler at each connector location in the set of connector locations 114 to form an array of couplers. Each coupler, in the array of couplers 115, includes a magnetic element 116 and an electronic communication port 118 (e.g., male pogo pin connector). In this implementation, the array of connector locations 14: are arranged in a lateral configuration across a top side of the input deck 113; and configured to couple the trackpad module 136 and the keyboard module 132 to the input deck 113 arranged over the first housing of the chassis 110. Furthermore, the electronic communication port 118 at each coupler, in the array of couplers 115 is: arranged across the top side of the input deck 113; proximal a magnetic element 116 at each connector location, in the array of connector locations 14; and configured to interface module connectors located at connector tabs of the trackpad module 136 and the keyboard module 132 in order to route electrical signals (e.g., power signals, data signals) to computing components within the chassis 110.

In one example, the modular computer system 100 includes an input deck 113: defining a base of a rectangular geometry spanning a top side of the first housing; inset from the top side of the housing to define a rectangular cavity; and configured to cover the set of computing components arranged within the first housing. In this example, the input deck 113 includes the array of couplers 115: arranged in a lateral configuration across the base of the input deck 113; and spanning across a length of the base to define an upper region 160 and a lower region 162 for the base of the input deck 113.

In particular, a first coupler, in the array of couplers 115, can include a first magnetic element 116: arranged proximal a first lateral side edge of the base of the input deck 113; and arranged at a mid-point between the upper region 160 and the lower region 162 of the input deck 113. Furthermore, the first coupler in the array of couplers 115, can include a second magnetic element 116: arranged adjacent the first magnetic element 116 opposite the first lateral side edge of the base of the input deck 113; arranged at a midpoint-between the upper region 160 and the lower region 162 of the input deck 113; and defining a first spacing between the first magnetic element 116 and the second magnetic element 116. Similarly, subsequent couplers, in the array of couplers 115, are arranged adjacent the first coupler to define: a linear arrangement of couplers extending from the first lateral side edge of the base to a second lateral side edge, opposite the first lateral side edge.

In the aforementioned example, the first coupler includes the electronic communication port 118 arranged at the spacing between the first magnetic element 116 and the second magnetic element 116.

Furthermore, the array of connector locations 114 can include a first subarray of connector locations and a second subarray of connector locations arranged across the input deck 113. In particular, the first subarray of connector locations: is arranged proximal the first lateral side edge of the input deck 113; and defines a first linear arrangement of connector locations between the upper region 160 and the lower region 162 of the input deck 113. Furthermore, the second subarray of connector locations: is arranged proximal a second lateral side edge of the input deck 113, opposite the first lateral side edge; and defines a second linear arrangement of electronic communication port 118s between the upper region 160 and the lower region 162 of the input deck 113.

In one implementation, the modular computer system 100 can execute a scan cycle in order to: read electrical values from the electronic communication port 118 at each connector location, in the set of connector location; and detect presence of input modules and/or spacer modules arranged across the input deck 113 based on these electrical values. For example, the system can: read voltage values from the electronic communication port 118; and detect presence of a resistor divider at the input modules based on voltage values retrieved from each electronic communication port 118. The system can then: interpret an operating mode for the input deck 113 in response to detecting presence of a module coupled to each electronic communication port 118 in the array of couplers 115 across the input deck 113; and/or interpret a modification mode for the input deck 113 in response to detecting absence of a module from an electronic communication port 118 in the array of couplers 115. In the modification mode, the modular computer system 100 can terminate routing of power signals to the input modules thereby allowing for a user to safely reconfigure modules across the input deck 113 while minimizing risk of electrical failure during removing and mounting of modules across the input deck 113.

Therefore, the modular computer system 100 can include an array of couplers 115: defining an upper region 160 and a lower region 162 of the input deck 113; and including an electronic communication port 118 and a magnetic element 116 configured to interface with a connector tab of the trackpad module 136 and the keyboard module 132. As a result, the input deck 113: can selectively receive a set of input modules, such as the trackpad module 136 and the keyboard module 132, in various positions across the upper region 160 and the lower region 162 of the input deck 113 via magnetic coupling to the magnetic element 116; and can interface the set of input modules via the electronic communication port 118 to route electrical signals (e.g., power signals, data signals) between the set of input modules and computing components within the chassis 110.

### 6. Module Kit

Generally, the modular computer system 100 includes a set of input modules including: a keyboard module 132 arranged across the upper region 160 of the input deck 113; and a trackpad module 136 arranged across the lower region 162 of the input deck 113. Each input module, in the set of input modules, includes a connector tab transiently couplable to the array couplers 115 across the input deck 113 in order to selectively position the input module in a preferred configuration (e.g., right-sided configuration, left-sided configuration, center configuration) according to a user's preferences during operation of the modular computer system 100.

### 6.1 Connector Tab

In one implementation, the modular computer system 100 includes each of the input modules and the keyboard module 132 including a connector tab. The connector tab: is configured to magnetically couple at a first coupler, in the array of couplers 115, across the input deck 113; and includes a module connector (e.g., 6-pin connector) configured to interface with an electronic communication port 118 at the first connector location. In this implementation, the module connector is configured to transfer electrical signals (e.g., data signals) from the trackpad module 136 and/or the keyboard module 132 to the set of computing components within the first housing of the chassis 110. The modular computer system 100 can then implement one or more data transfer protocols, such as USB, USB 2.0 and USB 3.0, to communicably couple the keyboard module 132 to the set of computing components within the chassis 110.

In one example, the connector tab: is formed of a ferrous material configured to magnetically couple a magnetic element 116 arranged at a first coupler, in the array of couplers 115, across the input deck 113; is arranged on a bottom side of the trackpad module 136 and/or keyboard module 132; and includes a module connector (e.g., female pogo pin connecter) centrally arranged at the connector tab and configured to communicably couple the electronic communication port 118 at the first coupler, in the array of couplers 115, arranged across the input deck 113.

### 6.2 Hot-Swapping Modules

Generally, the modular computer system can remain (or “persist”) in an operating mode while an operator removes, replaces, reinstalls, and/or reconfigures modules across the input deck 113. More specifically, the modular computer system can continue to execute computational processes, charge or discharge its internal battery, and render images or visual content on its integrated or connected display while modules are removed, replaced, reinstalled, and/or reconfigured across the input deck 113 by an operator. Thus, the modular computer system can enable the operator to exchange (or “hot-swap”) a set of modules across the input deck 113—such as by rearranging the set of modules (e.g., trackpad module 136, keyboard module 132) currently arranged across the input deck 113, or by exchanging a first module (e.g., spacer module) installed on the input deck 113 with a number-pad module 148—without interrupting ongoing computational processes at the modular computer system, without closing or deactivating software or applications executing on the modular computer system, and without disabling or pausing content rendered on the display.

In one implementation, during an operating mode, the modular computer system 100 can: detect removal of a particular module (e.g., keyboard module 132, trackpad module 136) from the input deck 113 based on a set of electrical signals read from the array of couplers 115; and generate a notification for the operator in order to notify the operator regarding absence of the particular module (e.g., keyboard module 132, trackpad module 136). In this implementation, upon detecting removal of the particular module from the input deck 113, the modular computer system 100 can terminate (i.e., disable) power supplied to each coupler, in the array of couplers 115, arranged across the input deck 113. Thus, the modular computer system 100 can: detect removal of a particular module from the input deck 113 corresponding to an exposed state for the input deck 113, such as exposed to environmental conditions (e.g., dust), based on the set of electrical signals; and mitigate electrical shorts across the input deck 113 by blocking power directed to the array of couplers 115 arranged at the array of connector locations 114 across the input deck 113.

In one example, the modular computer system 100 can: read a set of electrical values from the array of couplers 115 on the input deck 113; detect coupling of the keyboard module 132 across the input deck 113 of the chassis 110 based on the set of electrical values; and detect de-coupling of the trackpad module 136 from the input deck 113 of the chassis 110 based on the set of electrical values. Additionally, in response to detecting de-coupling of the trackpad module 136, the modular computer system 100 can: terminate an operating mode for the keyboard module 132 to block electrical signals received from the keyboard module 132; generate a notification prompting a user to review connection of the keyboard module 132 and the trackpad module 136 across the input deck 113 prior to resuming an operating mode for the keyboard module 132 and the trackpad module 136; and display the notification at the display 120 for a user operating the modular computer system 100.

In another implementation, during an operating mode, the modular computer system 100 can: detect coupling (e.g., magnetic coupling, electronic coupling) of a set of modules across the input deck 113 of the chassis 110 based on a set of electrical signals read from the array of couplers 115; and, in response to detecting coupling of the set of modules, initiate a module operating mode (e.g., keyboard operating mode, trackpad operating mode) for each module in the set of modules coupled to the input deck 113. Thus, the modulation signal can: interpret an enclosed state for the input deck 113 (i.e., the set of modules enclose all regions on the input deck 113) based on the set of electrical signals; and, in response to interpreting the enclosed state, initialize a module operating state for the set of modules across the input deck 113 of the chassis no.

In one example, the modular computer system 100 can: read a set of electrical values from the array of couplers 115 on the input deck 113; detect coupling of the keyboard module 132 across the input deck 113 of the chassis no based on the set of electrical values; and detect coupling of the trackpad module 136 across the input deck 113 of the chassis no based on the set of electrical values. Accordingly, in response to detecting coupling of the keyboard module 132 and the trackpad module 136, the modular computer system 100 can initiate the keyboard module 132 and the trackpad module 136 into an operating mode to receive electrical signals from the array of keys 133 and the touch sensor 137.

Therefore, the modular computer system 100 can: at a first time, interpret an enclosed state for the input deck 113 on the chassis no; at a second time following the first time, interpret an exposed state for the input deck 113 on the chassis no responsive to removal of a particular module from the input deck 113; and, in response to interpreting the exposed state, block power to the array of couplers 115 across the input deck 113 to mitigate electrical shorting across the array of couplers 115 during exchanging (or hot-swapping) of a set of modules across the input deck 113.

### 6.3 Keyboard Module

In one implementation, the modular computer system 100 includes a keyboard module 132: including a set of alphanumeric keys (e.g., alphanumeric, QWERTY) arranged across a top side of the keyboard module 132; including a first connector tab 135 arranged on a bottom side of the keyboard module 132 configured couple at a first connector location, in the array of connector locations 114, of the input deck 113; and arranged across the upper region 16o of the input deck 113 in a first keyboard module 132 position. In this implementation, the keyboard module 132 can be arranged in one of a center configuration, a left-sided configuration, or a right-sided configuration across the upper region 160 of the input deck 113.

In one example, the keyboard module 132: is arranged across the upper region 160 of the input deck 113 proximal a left-lateral side of the first housing; defines a first area across the upper region 160 of the input deck 113; and defines a second area, less than the first area, across the upper region 160 of the input deck 113. In this example, the keyboard module 132: includes a first connector tab 135 coupled at a connector location proximal the left-lateral side of the first housing; and spans across the first area of the upper region 160 of the input deck 113 to form the left-sided configuration for the keyboard module 132. Similarly, the keyboard module 132: can be arranged across the upper region 160 of the input deck 113 proximal a right-lateral side of the first housing; includes the first connector tab 135 coupled at a connector location proximal the right-lateral side of the first housing; and spans across a first area of the upper region 160 of the input deck 113 to form the right-sided configuration for the keyboard module 132.

In another example, the keyboard module 132: is centrally arranged across the upper region 160 of the input deck 113; defines a first area across the upper region 160 of the input deck 113; defines a second area, less than the first area, adjacent the keyboard module 132 and proximal the left-lateral side of the first housing; and defines a third area, less than the first area, adjacent the keyboard module 132 and proximal a right-lateral side of the first housing of the chassis 110. In this example, the keyboard module 132: includes a first connector tab 135 coupled at a connector location proximal a center of the input deck 113; and spans the first area across the center of the upper region 160 of the input deck 113 to form the center configuration for the keyboard module 132.

In another implementation, the keyboard module 132 can include a set of connector tabs configured to couple (e.g., magnetically couple, electronically couple) a set of couplers (e.g., two couplers, three couplers), in the array of couplers 115 across the input deck 113. Accordingly, the set of connector tabs arranged on the keyboard module 132 cooperate with the array of couplers 115 to magnetically retain the keyboard module 132 to the input deck 113 on the chassis 110.

In one example, the keyboard module 132 includes a first connector tab 135: arranged proximal a first lateral side of the keyboard module 132; and a first plate. The first plate is: formed of a ferrous material configured to magnetically couple the array of couplers 115; and includes a printed circuit board including the first connector 134 configured to electronically couple the array of couplers 115. Additionally, the keyboard module 132 can include a second connector tab 139: arranged proximal a second lateral side, opposite the first lateral side, of the keyboard module 132; and including a second plate formed of a ferrous material configured to magnetically couple the array of couplers 115 and cooperate with the first plate to transiently retain the keyboard module 132 to the input deck 113.

Therefore, the keyboard module 132 can include: a first connector tab 135 coupling (e.g., electrically, magnetically) a first coupler, in the array of couplers 115, arranged across the input deck 113; and a second connector tab 139 coupling (e.g., electrically, magnetically) a second coupler—different from the first coupler—in the array of couplers 115, arranged across the input deck 113 and cooperating with the first connector tab 135 to retain the keyboard module 132 across the input deck 113.

Therefore, the modular computer system wo: can include a keyboard module 132 transiently mountable to the input deck 113; can include the keyboard module 132 selectively positioned across multiple areas across the upper region 160 of the input deck 113 according to preferences of a user operating the modular computer system 100; and is configured to detect keyboard inputs based on electrical signals output by the keyboard module 132 regardless of the keyboard module 132 position across the input deck 113.

### 6.4 Trackpad Module

In one implementation, the modular computer system 100 includes a trackpad module 136: including a touch sensor 137 arranged on a top side of the trackpad module 136; including a second connector tab 139 arranged on a bottom side of the trackpad module 136 configured to couple a second connector location, in the array of connector locations 114, different from the first connector location, on the input deck 113; and arranged across the lower region 162 of the input deck 113 in a first trackpad module 136 position. In this implementation, the trackpad module 136 can cooperate with the keyboard module 132 to be arranged in one of a center configuration, a left-sided configuration, or a right-sided configuration across the lower region 162 of the input deck 113.

In one example, the trackpad module 136: is arranged across the lower region 162 of the input deck 113 proximal the left-lateral side of the first housing; adjacent the keyboard module 132 arranged across the upper region 160 of the input deck 113; defines a first area across the lower region 162 of the input deck 113; and defines a second area, less than the first area, across the lower region 162 of the input deck 113. In this example, the trackpad module 136: includes a second connector tab 139 coupled at a second connector location, proximal the first connector location coupled to the first connector tab 135 of the keyboard module 132, and proximal the left-lateral side of the first housing; and spans across the first area of the lower region 162 of the input deck 113 to form the left-sided configuration for the trackpad module 136.

Similarly, the trackpad module 136 can: be arranged across the lower region 162 of the input deck 113 proximal the right-lateral side of the first housing; be adjacent the keyboard module 132 arranged across the upper region 160 of the input deck 113; include the second connector tab 139 coupled at a second connector location proximal the right-lateral side of the first housing; and span across a first area of the lower region 162 of the input deck 113 to form the right-sided configuration for the trackpad module 136.

In another example, the trackpad module 136: is centrally arranged across the lower region 162 of the input deck 113; is arranged proximal the trackpad module 136 across the upper region 160 of the input deck 113; defines a first area across the lower region 162 of the input deck 113; defines a second area, less than the first area, adjacent the trackpad module 136 and proximal the left-lateral side of the first housing; and defines a third area, less than the first area, adjacent the trackpad module 136 and proximal a right-lateral side of the first housing of the chassis 110. In this example, the trackpad module 136: includes the second connector tab 139 coupled at a second connector location proximal a center of the input deck 113; and spans the first area across the center of the lower region 162 of the input deck 113 to form the center configuration for the trackpad module 136.

Therefore, the modular computer system 100: can include a trackpad module 136 transiently mountable to the input deck 113; can include the trackpad module 136 selectively positioned across multiple areas across the lower region 162 of the input deck 113 according to preferences of the user operating the modular computer system Dm; and is configured to detect touch inputs based on electrical signals output by the trackpad module 136 regardless of the trackpad module 136 position across the input deck 113.

### 6.5 Spacer Modules

Generally, the modular computer system 100 includes a set of spacer modules: arranged across the input deck 113 adjacent the keyboard module 132 and the trackpad module 136; and cooperating with the keyboard module 132 and the trackpad module 136 to maintain the keyboard module 132 and the trackpad module 136 in a first position across the input deck 113 of the chassis no. The set of spacer modules can include a connector tab, as previously described, to mount the spacer modules at connector locations across the input deck 113. More specifically, each spacer module, in the set of spacer modules: defines a rectangular geometry; includes a spacer module connector configured to magnetically couple the array of couplers 115 to transiently retain the spacer module across the input deck 113; and cooperates with the keyboard module 132 and the trackpad module 136 to enclose regions of the input deck 113 outside of the keyboard module 132 and the trackpad module 136 and to retain lateral positions of the keyboard module 132 and the trackpad module 136 in the first configuration.

In one implementation, the keyboard module 132 arranged across the upper region 160 of the input deck 113: defines a first area and a second area of the upper region 160 of the input deck 113. The keyboard module 132 spans the first area over the upper region 160 of the input deck 113, and the second area across the upper region 160 of the input deck 113 remains exposed. As a result, a spacer module, in the set of spacer modules, is arranged over the second area across the input deck 113 to entirely overlay the upper region 160 of the input deck 113.

In one example of this implementation, the keyboard module 132 is arranged in a left-sided configuration across the upper region 160 of the input deck 113 to define: a first area across the upper region 160 of the input deck 113, and proximal a left-lateral side of the first housing of the chassis no; and a second area, less than the first area, across the upper region 160 of the input deck 113, and proximal a right-lateral side of the first housing of the chassis 110. In this example, a first spacer module 140, in the set of spacer modules, is arranged at the second area of the upper region 160 of the input deck 113 and thereby: entirely overlays the upper region 160 of the input deck 113; and maintains the keyboard module 132 in the left-sided configuration across the upper region 160 of the input deck 113.

Similarly, the set of spacer modules can be implemented across the upper region 160 of the input deck 113 to maintain the keyboard module 132 in a right-sided configuration, as previously described. Furthermore, the set of spacer modules can be implemented across the lower region 162 of the input deck 113 to maintain the trackpad module 136 in a left-sided configuration or right-sided configuration.

In another implementation, each of the trackpad module 136 and the keyboard module 132 are arranged in a center configuration across the upper region 160 and the lower region 162 of the input deck 113, and thereby defines exposed areas of the input deck 113 adjacent a left-side and a right-side of the trackpad module 136 and the keyboard module 132. In this implementation, the set of spacer modules can be arranged about the exposed areas of the input deck 113 to: entirely overlay the input deck 113; and maintain the trackpad module 136 and the keyboard module 132 in a center configuration on the input deck 113.

In one example, the module kit 130 further includes a first spacer module 140: defining a first rectangular geometry; and including a third connector 141 configured to magnetically couple the array of couplers 115 to transiently retain the spacer module across the input deck 113. Additionally, the module kit 130 further includes a second spacer module 142: defining a second rectangular geometry congruent the first rectangular geometry; and including a fourth connector 143 configured to magnetically couple the array of couplers 115 to transiently retain the spacer module across the input deck 113.

In this example, the module kit 130 is operable in a second configuration, different from the first configuration, in which the modular computer system 100 includes the first spacer module 140: spanning a first area in the upper region 160 of the input deck 113 to locate the third connector 141 over a third connector 141 location in the array of connector locations 114; and arranged proximal a first lateral side of the input deck 113. Additionally, in a second configuration, the modular computer system 100 includes the second spacer module 142: spanning a second area in the upper region 160 of the input deck 113 to locate the fourth connector 143 over a fourth connector 143 location in the array of connector locations 14; and arranged proximal a second lateral side, opposite the first lateral side, of the input deck 113. Furthermore, in the second configuration, the modular computer system 100 includes: the keyboard module 132 spanning a third area, interposed between the first area and the second area, in the upper region 160 of the input deck 113 to locate the first connector 134 over the first connector location in the array of connector locations 14; and the trackpad module 136 spanning the lower region 162—adjacent the upper region 160—of the input deck 113 to locate the second connector 138 over the second connector location in the array of connector locations 114.

Therefore, during operation in the second configuration, the modular computer system 100 can centrally locate the keyboard module 132 on the upper region 160 of the input deck 113 to accommodate ergonomic preferences of an operator.

In another example, the module kit 130 is operable in a third configuration in which the modular computer system 100 includes the first spacer module 140: spanning a first area in the upper region 160 of the input deck 113 to locate the third connector 141 over a third connector 141 location in the array of connector locations 14; and arranged proximal a first lateral side of the input deck 113. Additionally, in the third configuration, the modular computer system 100 includes the second spacer module 142: spanning a second area in the lower region 162, adjacent the first area in the upper region 160, of the input deck 113 to locate the fourth connector 143 over a fourth connector 143 location in the array of connector locations 14; and arranged proximal the first lateral side of the input deck 113. In the third configuration, the modular computer system 100 also includes the keyboard module 132: spanning a third area in the upper region 160 of the input deck 113 to locate the first connector 134 over the first connector location in the array of connector locations 14; and arranged proximal a second lateral side, opposite the first lateral side, of the input deck 113. In the third configuration, the modular computer system 100 further includes the trackpad module 136: spanning a fourth area in the lower region 162, adjacent the third area in the upper region 160, of the input deck 113 to locate the second connector 138 over the second connector location in the array of connector locations 14; and arranged proximal the second lateral side, opposite the first lateral side, of the input deck 113.

Therefore, during operation in the second configuration, the modular computer system 100 can locate the keyboard module 132 and the trackpad module 136 proximal a lateral side of the input deck 113 on the chassis 110 to accommodate ergonomic preferences of an operator.

### 6.6 Number-Pad Module

In one implementation, the modular computer system 100 can further include a number pad module: including a set of number keys; arranged across the upper region 160 of the input deck 113; arranged adjacent the keyboard module 132 across the upper region 160 of the input deck 113; and including a connector tab configured to communicably couple a second connector location at the input deck 113, different from the first connector location coupled to the first connector tab 135 of the keyboard module 132.

In one example, of this implementation, the keyboard module 132 is arranged in a left-sided configuration across the upper region 160 of the input deck 113 to define: a first area across the upper region 160 of the input deck 113, and proximal a left-lateral side of the first housing of the chassis no; and a second area, less than the first area, across the upper region 160 of the input deck 113, and proximal a right-lateral side of the first housing of the chassis no. In this example, the number pad module is arranged at the second area of the upper region 160 of the input deck 113 and thereby: entirely overlays the upper region 160 of the input deck 113; maintains the keyboard module 132 in the left-sided configuration across the upper region 160 of the input deck 113; and maintains the number pad module in a right-sided configuration across the upper region 160 of the input deck 113.

In another implementation, the modular computer system 100 can similarly include a number pad arranged: across the lower region 162 of the input deck 113; and adjacent the trackpad module 136 across the lower region 162 of the input deck 113.

In another example, the module kit 130 further includes a number-pad module 148 including: a second array of keys 149 arranged on a first side of the number-pad module 148 and corresponding to an array of numerical and mathematical symbols; and a third connector 141. The third connector 141 is: arranged on a second side, opposite the first side, of the number-pad module 148; configured to magnetically couple the array of couplers 115 to transiently retain the number-pad module 148 across the input deck 113; and configured to electronically couple the array of couplers 115 to transmit electrical signals from the second array of keys 149 to the controller 112.

In this example, the module kit 130 is operable in a second configuration in which the modular computer system includes the keyboard module 132: spanning a first area in the upper region 160 of the input deck 113 to locate the first connector 134 over the first connector location in the array of connector locations 14; and arranged proximal a first lateral side of the input deck 113. Additionally, in the second configuration, the modular computer system 100 includes the number-pad module 148: spanning a second area, adjacent the first area, in the upper region 160 of the input deck 113 to locate the third connector 141 over a third connector 141 location in the array of connector locations 114; and arranged proximal a second lateral side, opposite the first lateral side, of the input deck 113. In the second configuration, the modular computer system 100 also includes the trackpad module 136 spanning the lower region 162, adjacent the upper region 160, of the input deck 113 to locate the second connector 138 over the second connector location in the array of connector locations 114.

Accordingly, in this example the module kit 130 includes: the keyboard module 132 including a first rectangular geometry spanning the first area of the upper region 160 of the input deck 113; and the number-pad module 148 including a second rectangular geometry—less than the first rectangular geometry—spanning the second area of the upper region 160 of the input deck 113. Furthermore, the trackpad module 136 includes a third rectangular geometry, greater than the first rectangular geometry, spanning the lower region 162 of the input deck 113.

Therefore, in this example, the trackpad module 136 cooperates with the keyboard module 132 and the number-pad module 148 to entirely enclose the input deck 113 on the chassis 110.

### 6.7 Display Module

In one implementation, the modular computer system 100 can further include a display module 152: including a display element (e.g., LED display 120); arranged across the input deck 113; and coupled to the main board arranged within the first housing of the chassis 110. In this implementation, the display module 152 can include a connector tab to couple the display module 152 at connector locations across the input deck 113 and thereby route electrical signals (e.g., data signals, power signals) between the set of computing components and the display module 152. The modular computer system 100 can then transmit data, such as notifications and prompts to the display module 152.

In one example, the modular computer system 100 can: access a set of electrical values from an expansion card slot at the first housing of the chassis 110; detect presence of an expansion card at the expansion card slot based on the set of electrical values; and identify a type of expansion card based on the set of electrical values. The modular computer system 100 can then, in response to detecting presence of the expansion card at the expansion card slot: generate a notification indicating presence of the expansion card at the expansion card slot and the expansion card type; and transmit the notification at the display module 152 for a user operating the modular computer system 100.

In another example, the module kit 130 further includes a display module 152 including: a display 120 arranged on a first side of the display module 152 and including an array of light elements 153; and a third connector 141. The third connector 141 is: arranged on a second side, opposite the first side, of the display module 152; configured to magnetically couple the array of couplers 115 to transiently retain the display module 152 across the input deck 113; and configured to electronically couple the array of couplers 115 to transmit electrical signals from the array of light elements 153 to the controller 112.

In this example, the module kit 130 is operable in a second configuration in which the modular computer system includes the keyboard module 132: spanning a first area in the upper region 160 of the input deck 113 to locate the first connector 134 over the first connector location in the array of connector locations 14; and arranged proximal a first lateral side of the input deck 113. In the second configuration, the modular computer system 100 further includes the display module 152: spanning a second area, adjacent the first area, in the upper region 160 of the input deck 113 to locate the third connector 141 over a third connector 141 location in the array of connector locations 14; and arranged proximal a second lateral side, opposite the first lateral side, of the input deck 113. Furthermore, in the second configuration, the modular computer system 100 includes: the trackpad module 136 spanning the lower region 162, adjacent the upper region 160, of the input deck 113 to locate the second connector 138 over the second connector location in the array of connector locations 114.

In another implementation, the modular computer system 100 can: read electrical values from a suite of components (e.g., wireless connection receivers, battery pack); interpret states (e.g., battery level, connection strength) of the suite of components arranged within the chassis 110; and display the states for the suite of components at the display module 152 arranged at the input deck 113 of the chassis 110. Additionally, the modular computer system 100 can: detect removal of a particular module from the input deck 113 on the chassis 110; generate a notification for an operator to manually review coupling of the modules arranged across the input deck 113; and display the notification on the display module 152 arranged on the input deck 113.

In one example, the modular computer system 100 can: at a first time, read a first set of electrical values from the array of couplers 115 on the input deck 113; detect coupling of the keyboard module 132 across the input deck 113 of the chassis 110 based on the first set of electrical values; and detect coupling of the trackpad module 136 across the input deck 113 of the chassis no based on the first set of electrical values. Accordingly, in response to detecting coupling of the keyboard module 132 and the trackpad module 136, the modular computer system 100 can trigger illumination of the array of light elements 153 in a first pattern.

Furthermore, at a second time following the first time, the modular computer system 100 can: read a second set of electrical values from the array of couplers 115 on the input deck 113; and detect de-coupling of the trackpad module 136 from the input deck 113 of the chassis no based on the second set of electrical values. Thus, in response to detecting de-coupling of the trackpad module 136, the modular computer system 100 can trigger illumination of the array of light elements 153 in a second pattern, different from the first pattern.

Therefore, the modular computer system 100 can: read electrical signals from a suite of components (e.g., battery, transceivers, ports) in the chassis no; interpret states (e.g., battery level, signal strength) of the suite of components based on the electrical values; and trigger illumination of the array of light elements 153, such as in a particular pattern, representing the states of the suite of components.

### 6.8 Voice Module

In one implementation, the module kit 130 further includes a voice module 144 including: a speaker component 145 (e.g., piezo speaker, conical speaker) arranged on a first side of the voice module 144; an audio sensor (e.g., microphone) arranged on the first side of the voice module 144; and a third connector 141 arranged on a second side, opposite the first side of the voice module 144. In this implementation, the third connector 141 is configured to: magnetically couple the array of couplers 115 to transiently retain the voice module 144 to the input deck 113 on the chassis no; and electrically couple the array of couplers 115 to transmit electrical signals from the speaker and the microphone to the controller 112.

In one example, the module kit 130 is operable in a second configuration in which the modular computer system 100 includes: a first voice module 144 arranged across a first area in the upper region 160 of the input deck 113; a second voice module arranged across a second area in the upper region 160 of the input deck 113; and the keyboard module 132 arranged interposed between the first voice module 144 and the second voice module. Accordingly, the first voice module 144 cooperates with the second voice module to form a stereo speaker system configured to broadcast audible media from a first direction and a second direction relative the chassis 110.

In another example, the modular computer system 100 can: read a set of electrical values from the array of couplers 115 on the input deck 113; and detect de-coupling of the trackpad module 136 from the input deck 113 of the chassis no based on the set of electrical values. Furthermore, in response to detecting de-coupling of the trackpad module 136, the modular computer system 100 can: access an audible alert at a first frequency corresponding to de-coupling of the trackpad module 136 from the input deck 113; and broadcast the audible alert at the first frequency at the first speaker component 145 at the first spacer module 140 and the second speaker component at the second spacer module 142.

Therefore, the modular computer system 100 can: read electrical signals representing audio signals from the audio sensor at the voice module 144; broadcast audio signals from the speaker at the voice module 144; and selectively locate the voice module 144 across regions of the input deck 113 on the chassis 110.

### 6.9 Haptic Feedback Module

In one implementation, the module kit 130 further includes a haptic feedback module 146 including: a vibration component 147 (e.g., motor, coil+magnets) arranged within the haptic feedback module 146; and the third connector 141 configured to couple (e.g., electrically, magnetically) the array of couplers 115 on the input deck 113 to transiently retain the haptic feedback module 146 across the input deck 113 and transmit electrical signals from the controller 112 to the vibration component 147. Thus, the modular computer system 100 can drive an electrical signal to the vibration component 147, such as responsive to touch inputs received at the touch sensor 137 and/or responsive to broadcasting notifications at the display 120 coupled to the chassis 110.

In one example, the modular computer system 100 can: read a set of electrical values from the array of couplers 115 on the input deck 113; detect de-coupling of the trackpad module 136 from the input deck 113 of the chassis no based on the set of electrical values; and, in response to detecting de-coupling of the trackpad module 136, drive a first electrical signal to the first haptic feedback element in the first spacer module 140 to oscillate the first spacer module 140 relative the chassis 110. Therefore, the modular computer system 100 can: detect inputs at a set of modules arranged across the input deck 113 on the chassis 110; and, in response to detecting the inputs, trigger the vibration component 147 to oscillate and thus generate haptic feedback response at the haptic feedback module 146 relative the chassis 110.

### 6.10 Trackball Module

In one implementation, the modular computer system 100 includes a trackball module 154 including: a spherical element protruding from a first side of the trackball module 154; an encoder (e.g., roller, optical) coupled to the spherical element configured to output electrical signals responsive to rotation of the spherical element; and a third connector 141 arranged on a second side, opposite the first side, of the trackball module 154. Additionally, the third connector 141 is configured to: magnetically couple the array of couplers 115 to transiently retain the trackball module 154 across the input deck 113; and electronically couple the array of couplers 115 to transmit electrical signals from the trackball module 154 to the controller 112.

In one example, the module kit 130 is operable in a second configuration in which the modular computer system 100 includes: the keyboard module 132 spanning the upper region 160 of the input deck 113 and the first connector 134 arranged over the first connector location in the array of connector locations 114; and the trackball module 154 spanning the lower region 162, adjacent the upper region 160, of the input deck 113 and the third connector 141 arranged over a third connector 141 location in the array of connector locations 114. Therefore, during operation in this second configuration, the modular computer system 100 can: read electrical signals from the encoder at the trackball module 154; interpret a touch input applied at the spherical element by an operator based on the electrical signals; and transform the touch input, such as by modifying a cursor at the display 120 coupled to the chassis no.

### 7.0 Example: Region Based Modules

In one example, the module kit 130 can include: a first keyboard module 132 corresponding to a keyboard layout for Latin-script alphabets (e.g., QWERTY keyboard layout); and a second keyboard module 150 corresponding to a keyboard layout for glyph-based (e.g., Hangul, Mandarin) alphabets. Accordingly, an operator can exchange the first keyboard module 132 and the second keyboard module 150 on the input deck 113 to alternate between configurations corresponding to the Latin-script alphabets and glyph-based alphabets.

In one example, the first keyboard module 132 includes the array of keys 133 corresponding to an array of alpha-numerical symbols arranged in a QWERTY keyboard layout. Additionally, the module kit 130 can include a second keyboard module 150 including: a second array of keys 149 arranged on a first side of the second keyboard module 150 and corresponding to an array of Hangul-glyph symbols arranged in a dubeolsik (or “two-set”) layout; and a third connector 141 arranged on a second side, opposite of the first side, of the second keyboard module 150. Additionally, the third connector 141 is configured to: magnetically couple the array of couplers 115 to transiently retain the second keyboard module 150 across the input deck 113; and electronically couple the array of couplers 115 to transmit electrical signals from the second array of keys 149 to the controller 112.

Accordingly, the module kit 130 is operable in a first configuration including the first keyboard module 132 spanning the upper region 160 of the input deck 113; and the trackpad module 136 spanning the lower region 162, adjacent the upper region 160, of the input deck 113. Alternatively, the module kit 130 is also operable in the second configuration in which the modular computer system 100 includes the second keyboard module 150: spanning the upper region 160 of the input deck 113; and the trackpad module 136 spanning the lower region 162, adjacent the upper region 16o, of the input deck 113.

Therefore, during an operational period of the modular computer system 100, an operator can seamlessly exchange a first keyboard module 132 corresponding to a first keyboard layout for a second keyboard module 150 corresponding to a second keyboard layout.

### 6.7 Variations

Generally, the modular computer system 100 can include additional modules arranged across the input deck 113, such as speaker modules, gamepad modules, musical keyboard module 132s, and stream deck modules. These additional modules can include a connector tab, as previously described, to communicably couple these modules to the array of connector locations 114 arranged across the input deck 113.

### 7.0 Registering and Distributing Module Kit

As described in U.S. Non-Provisional application Ser. No. 17/736,765, filed on 4 May 2022, the modular computer system 100 can maintain a data store that includes a library, data set, or database of each module in the module kit, to include: a description; identifying information (e.g., serial number, date of manufacture, place of manufacture, lot/batch number); assigned QR code; and a website or web address to which the QR code redirects a user's mobile device browser. In one variation of the implementation, the library can additionally include a module record corresponding to an individual module in the module kit and include a record of consumption activity of the module. The consumption activity data can be aggregated into an integrity status of the module by the system 100. In one alternative implementation, the data store can also include a module registration and tracking dataset, through which the system 100 can: verify and authenticate the provenance of the module and, through cross-reference of the serial number, date/site of manufacture, and date of first retail sale; and validate the authenticity and safety of the module to its first and subsequent purchasers.

In one implementation, the modular computer system can 100: access a historical record of software applications previously executed on the controller; link modules in the module record—representing modules owned and operated by the user—to software applications in the historical record; and in response to identifying absence of a link between a software application in the historical record to a module in the module kit, prompting a user to retrieve a module for the software application. In particular, the modular computer system can: retrieve a module library representing a set of modules available for purchase by the user and compatible with the modular computer system; link the software application to a set of modules in the module library; generate a prompt for a user to select a set of modules compatible with the software application; and present the prompt, such as at an interactive display at the modular computer system 100. Thus, in response to receiving selection of a module in the set of modules from the user, the modular computer system can then redirect the user's mobile device browser to a web page associated with the module.

In one example, the modular computer system can: identify absence of a link between an audio software application (i.e., a graphic intensive application) and an audio module in the user's module kit; retrieve a module library containing a set of audio modules available for purchase by the user and compatible with the audio software application; generate a prompt for a user to select a particular audio module in the set of audio modules; and present the prompt at an interactive display at the modular computer system for the user. Therefore, the modular computer system can present recommendations for modules to a user to enable to user to improve computational and/or ergonomic performance of the modular computer system 100.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a controller 112 but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A modular computer system comprising:
a chassis comprising:
a controller;
an input deck defining an array of connector locations; and
an array of couplers, each coupler in the array of couplers:
arranged at a connector location, in the set of connector locations, on the input deck; and
comprising a magnetic element and an electronic communication port;
a display coupled to the chassis; and
a module kit:
comprising:
a keyboard module comprising:
an array of keys arranged on a first side of the keyboard module; and
a first connector:
arranged on a second side, opposite the first side, of the keyboard module;
configured to magnetically couple the array of couplers to transiently retain the keyboard module across the input deck; and
configured to electronically couple to the array of couplers to transmit electrical signals from the array of keys to the controller; and
a trackpad module comprising:
a touch sensor arranged on a first side of the trackpad module; and
a second connector:
arranged on a second side, opposite the first side, of the trackpad module;
configured to magnetically couple the array of couplers to transiently retain the trackpad module across the input deck; and
configured to electronically couple the array of couplers to transmit electrical signals from the touch sensor to the controller; and
operable in a first configuration comprising:
the keyboard module spanning an upper region of the input deck and the first connector arranged over a first connector location in the set of connector locations; and
the trackpad module spanning a lower region, adjacent the upper region, of the input deck and the second connector arranged over a second connector location, different from the first connector location, in the set of connector locations.

2. The system of claim 1, wherein the controller is configured to:
read a set of electrical values from the array of couplers on the input deck;
detect coupling of the keyboard module across the input deck of the chassis based on the set of electrical values;
detect de-coupling of the trackpad module from the input deck of the chassis based on the set of electrical values; and
in response to detecting de-coupling of the trackpad module:
terminate an operating mode for the keyboard module to block electrical signals received from the keyboard module;
generate a notification prompting a user to review connection of the keyboard module and the trackpad module across the input deck prior to resuming operating mode for the keyboard module and the trackpad module; and
display the notification at the display for a user operating the modular computer system.

3. The system of claim 1, wherein the controller is configured to:
read a set of electrical values from the array of couplers on the input deck;
detect coupling of the keyboard module across the input deck of the chassis based on the set of electrical values;
detect coupling of the trackpad module across the input deck of the chassis based on the set of electrical values; and
in response to detecting coupling of the keyboard module and the trackpad module:
initiate the keyboard module and the trackpad module into an operating mode to transmit electrical signals from the array of keys and the touch sensor to the controller.

4. The system of claim 1:
wherein the module kit further comprises:
a first spacer module:
defining a first rectangular geometry; and
comprising a third connector configured to magnetically couple the array of couplers to transiently retain the spacer module across the input deck; and
a second spacer module:
defining a second rectangular geometry congruent the first rectangular geometry; and
comprising a fourth connector configured to magnetically couple the array of couplers to transiently retain the spacer module across the input deck; and
wherein the module kit is operable in a second configuration comprising:
the first spacer module:
spanning a first area in the upper region of the input deck to locate the third connector over a third connector location in the set of connector locations; and
arranged proximal a first lateral side of the input deck;
the second spacer module:
spanning a second area in the upper region of the input deck to locate the fourth connector over a fourth connector location in the set of connector locations; and
arranged proximal a second lateral side, opposite the first lateral side, of the input deck;
the keyboard module spanning a third area, interposed between the first area and the second area, in the upper region of the input deck to locate the first connector over the first connector location in the set of connector locations; and
the trackpad module spanning the lower region, adjacent the upper region, of the input deck to locate the second connector over the second connector location in the set of connector locations.

5. The system of claim 4, wherein the module kit is operable in a third configuration comprising:
the first spacer module:
spanning a first area in the upper region of the input deck to locate the third connector over a third connector location in the set of connector locations; and
arranged proximal a first lateral side of the input deck;
the second spacer module:
spanning a second area in the lower region, adjacent the first area in the upper region, of the input deck to locate the fourth connector over a fourth connector location in the set of connector locations; and
arranged proximal the first lateral side of the input deck;
the keyboard module:
spanning a third area in the upper region of the input deck to locate the first connector over the first connector location in the set of connector locations; and
arranged proximal a second lateral side, opposite the first lateral side, of the input deck; and
the trackpad module:
spanning a fourth area in the lower region, adjacent the third area in the upper region, of the input deck to locate the second connector over the second connector location in the set of connector locations; and
arranged proximal the second lateral side, opposite the first lateral side, of the input deck.

6. The system of claim 4:
wherein the first spacer module further comprises a first speaker element arranged on a first side of the first spacer module;
wherein the second spacer module further comprises a second speaker element arranged on a first side of the second spacer module; and
wherein the controller is configured to:
read a set of electrical values from the array of couplers on the input deck;
detect de-coupling of the trackpad module from the input deck of the chassis based on the set of electrical values; and
in response to detecting de-coupling of the trackpad module:
access an audible alert at a first frequency corresponding to de-coupling of the trackpad module from the input deck; and
broadcast the audible alert at the first frequency at the first speaker element at the first spacer module and the second speaker element at the second spacer module.

7. The system of claim 4:
wherein the first spacer module further comprises a first vibration component arranged within the first spacer module; and
wherein the controller is configured to:
read a set of electrical values from the array of couplers on the input deck;
detect de-coupling of the trackpad module from the input deck of the chassis based on the set of electrical values; and
in response to detecting de-coupling of the trackpad module, drive a first electrical signal to the first vibration component in the first spacer module to oscillate the first spacer module relative the chassis.

8. The system of claim 1:
wherein the keyboard module comprises the set of keys corresponding to an array of alpha-numerical symbols arranged in a QWERTY keyboard layout;
wherein the module kit further comprises a number-pad module comprising:
a second set of keys arranged on a first side of the number-pad module and corresponding to an array of numerical and mathematical symbols; and
a third connector:
arranged on a second side, opposite the first side, of the number-pad module;
configured to magnetically couple the array of couplers to transiently retain the number-pad module across the input deck; and
configured to electronically couple the array of couplers to transmit electrical signals from the second set of keys to the controller; and
wherein the module kit is operable in a second configuration comprising:
the keyboard module:
spanning a first area in the upper region of the input deck to locate the first connector over the first connector location in the set of connector locations; and
arranged proximal a first lateral side of the input deck;
the number-pad module:
spanning a second area, adjacent the first area, in the upper region of the input deck to locate the third connector over a third connector location in the set of connector locations; and
arranged proximal a second lateral side, opposite the first lateral side, of the input deck; and
the trackpad module spanning the lower region, adjacent the upper region, of the input deck to locate the second connector over the second connector location in the set of connector locations.

9. The system of claim 8:
wherein the keyboard module comprises a first rectangular geometry spanning the first area of the upper region of the input deck;
wherein the number-pad module comprises a second rectangular geometry, less than the first rectangular geometry, spanning the second area of the upper region of the input deck; and
wherein the trackpad module comprises a third rectangular geometry, greater than the first rectangular geometry, spanning the lower region of the input deck, the trackpad module cooperating with the keyboard module and the number-pad module to entirely enclose the input deck on the chassis.

10. The system of claim 1:
wherein the keyboard module comprises the set of keys corresponding to an array of alpha-numerical symbols arranged in a QWERTY keyboard layout;
wherein the module kit further comprises a second keyboard module comprising:
a second set of keys:
arranged on a first side of the second keyboard module; and
corresponding to an array of Hangul-glyph symbols arranged in a dubeolsik layout;
a third connector:
arranged on a second side, opposite of the first side, of the second keyboard module;
configured to magnetically couple the array of couplers to transiently retain the second keyboard module across the input deck; and
configured to electronically couple the array of couplers to transmit electrical signals from the second array of keys to the controller; and
wherein the module kit is operable in a second configuration comprising:
the second keyboard module spanning the upper region of the input deck and the third connector arranged over a third connector location in the set of connector locations; and
the trackpad module spanning the lower region, adjacent the upper region, of the input deck and the second connector arranged over the second connector location in the set of connector locations.

11. The system of claim 1:
wherein the module kit further comprises a display module comprising:
a second display arranged on a first side of the display module and comprising an array of light elements; and
a third connector:
arranged on a second side, opposite the first side, of the display module;
configured to magnetically couple the array of couplers to transiently retain the display module across the input deck; and
configured to electronically couple the array of couplers to transmit electrical signals from the array of light elements to the controller; and
wherein the module kit is operable in a second configuration:
the keyboard module:
spanning a first area in the upper region of the input deck to locate the first connector over the first connector location in the set of connector locations; and
arranged proximal a first lateral side of the input deck;
the display module:
spanning a second area, adjacent the first area, in the upper region of the input deck to locate the third connector over a third connector location in the set of connector locations; and
arranged proximal a second lateral side, opposite the first lateral side, of the input deck; and
the trackpad module spanning the lower region, adjacent the upper region, of the input deck to locate the second connector over the second connector location in the set of connector locations.

12. The system of claim 11, wherein the controller is configured to:
at a first time, read a first set of electrical values from the array of couplers on the input deck;
detect coupling of the keyboard module across the input deck of the chassis based on the first set of electrical values;
detect coupling of the trackpad module across the input deck of the chassis based on the first set of electrical values;
in response to detecting coupling of the keyboard module and the trackpad module, trigger illumination of the array of light elements in a first pattern;
at a second time following the first time, read a second set of electrical values from the array of couplers on the input deck;
detect de-coupling of the trackpad module from the input deck of the chassis based on the second set of electrical values; and
in response to detecting de-coupling of the trackpad module, trigger illumination of the array of light elements in a second pattern, different from the first pattern.

13. The system of claim 1, wherein the keyboard module further comprises:
a first connector tab:
arranged proximal a first lateral side of the keyboard module; and
comprising a first plate:
formed of a ferrous material configured to magnetically couple the array of couplers; and
comprising a printed circuit board comprising the first connector configured to electronically couple the array of couplers; and
a second connector tab:
arranged proximal a second lateral side, opposite the first lateral side, of the keyboard module; and
comprising a second plate formed of a ferrous material configured to magnetically couple the array of couplers and cooperate with the first plate to transiently retain the keyboard module to the input deck.

14. The system of claim 1:
wherein the module kit further comprises a trackball module comprising:
a spherical element protruding from a first side of the trackball module;
an encoder coupled to the spherical element configured to output electrical signals responsive to rotation of the spherical element; and
a third connector:
arranged on a second side, opposite the first side, of the trackball module;
configured to magnetically couple the array of couplers to transiently retain the trackball module across the input deck; and
configured to electronically couple the array of couplers to transmit electrical signals from the trackball module to the controller; and
wherein the module kit is operable in a second configuration comprising:
the keyboard module spanning the upper region of the input deck and the first connector arranged over the first connector location in the set of connector locations; and
the trackball module spanning the lower region, adjacent the upper region, of the input deck and the third connector arranged over a third connector location in the set of connector locations.

15. The system of claim 1, wherein the module kit further comprises a set of spacer modules, each spacer module in the set of spacer modules:
defining a rectangular geometry;
comprising a spacer module connector configured to magnetically couple the array of couplers to transiently retain the spacer module across the input deck; and
cooperating with the keyboard module and the trackpad module to enclose regions of the input deck outside of the keyboard module and the trackpad module and to retain lateral positions of the keyboard module and the trackpad module in the first configuration.

16. A modular computer system comprising:
a chassis comprising an input deck comprising an array of couplers, each coupler in the array of couplers comprising a magnetic element and an electronic communication port;
a controller; and
a module kit:
comprising:
a keyboard module comprising:
an array of keys; and
a first connector:
configured to magnetically couple the array of couplers to transiently retain the keyboard module across the input deck; and
configured to electronically couple to the array of couplers to transmit electrical signals from the array of keys to the controller;
a trackpad module comprising:
a touch sensor; and
a second connector:
configured to magnetically couple the array of couplers to transiently retain the trackpad module across the input deck; and
configured to electronically couple the array of couplers to transmit electrical signals from the touch sensor to the controller;
a set of spacer modules, each spacer module in the set of spacer modules comprising:
a rectangular geometry; and
a spacer module connector configured to magnetically couple the array of couplers to transiently retain the spacer module across the input deck; and
operable in a first configuration comprising:
the keyboard module spanning an upper region of the input deck and the first connector arranged over a first connector location in the set of connector locations;
the trackpad module spanning a lower region, adjacent the upper region, of the input deck and the second connector arranged over a second connector location, different from the first connector location, in the set of connector locations; and
the set of spacer modules cooperating with the keyboard module and the trackpad module to:
enclose regions of the input deck outside of the keyboard module and the trackpad module; and
retain lateral positions of the of the keyboard module and the trackpad module in the first configuration.

17. The system of claim 16:
wherein the keyboard module comprises the set of keys corresponding to an array of alpha-numerical symbols arranged in a QWERTY keyboard layout;
wherein the module kit further comprises a second keyboard module comprising:
a second set of keys:
arranged on a first side of the second keyboard module; and
corresponding to an array of Hangul-glyph symbols arranged in a dubeolsik layout; and
a third connector:
arranged on a second side, opposite of the first side, of the second keyboard module;
configured to magnetically couple the array of couplers to transiently retain the second keyboard module across the input deck; and
configured to electronically couple the array of couplers to transmit electrical signals from the second array of keys to the controller; and
wherein the module kit is operable in a second configuration comprising:
the second keyboard module spanning the upper region of the input deck and the third connector arranged over a third connector location in the set of connector locations; and
the trackpad module spanning the lower region, adjacent the upper region, of the input deck and the second connector arranged over the second connector location in the set of connector locations.

18. The system of claim 16:
wherein the module kit further comprises a display module comprising:
a display arranged on a first side of the display module and comprising an array of light elements; and
a third connector:
arranged on a second side, opposite the first side, of the display module;
configured to magnetically couple the array of couplers to transiently retain the display module across the input deck; and
configured to electronically couple the array of couplers to transmit electrical signals from the array of light elements to the controller; and
wherein the module kit is operable in a second configuration:
the keyboard module:
spanning a first area in the upper region of the input deck to locate the first connector over the first connector location in the set of connector locations; and
arranged proximal a first lateral side of the input deck;
the display module:
spanning a second area, adjacent the first area, in the upper region of the input deck to locate the third connector over a third connector location in the set of connector locations; and
arranged proximal a second lateral side, opposite the first lateral side, of the input deck; and
the trackpad module spanning the lower region, adjacent the upper region, of the input deck to locate the second connector over the second connector location in the set of connector locations.

19. The system of claim 16:
wherein the module kit further comprises a number-pad module comprising:
a second set of keys arranged on a first side of the number-pad module and corresponding to an array of numerical and mathematical symbols; and
a third connector:
arranged on a second side, opposite the first side, of the number-pad module;
configured to magnetically couple the array of couplers to transiently retain the number-pad module across the input deck; and
configured to electronically couple the array of couplers to transmit electrical signals from the second set of keys to the controller; and
wherein the module kit is operable in a second configuration comprising:
the keyboard module:
spanning a first area in the upper region of the input deck to locate the first connector over the first connector location in the set of connector locations; and
arranged proximal a first lateral side of the input deck;
the number-pad module:
spanning a second area, adjacent the first area, in the upper region of the input deck to locate the third connector over a third connector location in the set of connector locations; and
arranged proximal a second lateral side, opposite the first lateral side, of the input deck; and
the trackpad module spanning the lower region, adjacent the upper region, of the input deck to locate the second connector over the second connector location in the set of connector locations.

20. A modular computer system comprising:
a chassis comprising an input deck comprising an array of couplers, each coupler in the array of couplers comprising a magnetic element and an electronic communication port;
a controller;
a keyboard module comprising:
an array of keys arranged on a first side of the keyboard module; and
a first connector:
arranged on a second side, opposite the first side, of the keyboard module;
configured to magnetically couple the array of couplers to transiently retain the keyboard module across the input deck; and
configured to electronically couple to the array of couplers to transmit electrical signals from the array of keys to the controller;
a trackpad module comprising:
a touch sensor arranged on a first side of the trackpad module; and
a second connector:
arranged on a second side, opposite the first side, of the trackpad module;
configured to magnetically couple the array of couplers to transiently retain the trackpad module across the input deck; and
configured to electronically couple the array of couplers to transmit electrical signals from the touch sensor to the controller;
a number-pad module comprising:
a second set of keys arranged on a first side of the number-pad module and corresponding to an array of numerical and mathematical symbols; and
a third connector:
arranged on a second side, opposite the first side, of the number-pad module;
configured to magnetically couple the array of couplers to transiently retain the number-pad module across the input deck; and
configured to electronically couple the array of couplers to transmit electrical signals from the second set of keys to the controller.
